(19) United States
(12) Patent Application Publication
(10) Pub. No.: US 2006/0004175 A1
(43) Pub. Date: Jan. 5, 2006

(54) Method for producing a polyurethane prepolymer

(76) Inventors: Guido Kollbach, Straelen (DE); Nina Hassel, Kerken (DE); Hans-Georg Kinzelmann, Pulheim (DE); Oliver Steil, Duesseldorf (DE); Heike U. Hupfer-Bolte, Monheim (DE)

Correspondence Address: HENKEL CORPORATION, THE TRIAD, SUITE 200, 2200 RENAISSANCE BLVD., GULPH MILLS, PA, 19406, US

(21) Appl. No.: 11/148,399

(22) Filed: Jun. 8, 2005

Related U.S. Application Data
(63) Continuation of application No. PCT/EP03/13848, filed on Dec. 6, 2003.

(30) Foreign Application Priority Data
Dec. 17, 2002 (DE) 102 59 249.7

(51) Int. Cl. C08G 18/08

(52) U.S. Cl. 528/53

(57) ABSTRACT

A method for producing a polyurethane prepolymer having terminal isocyanate groups is provided wherein one or more polyisocyanates are reacted with one or more polyols and wherein at least one asymmetric diisocyanate, at least one polyol having an average molecular weight (Mₙ) of 60 to 3000 g/mol, and at least one carboxamide catalyst are used. The ratio of isocyanate groups to hydroxyl groups is set in the range between 1.1:1 to 4:1.

### CROSS-REFERENCE TO RELATED APPLICATIONS

This application is a continuation under 35 USC Sections 365(c) and 120 of International Application No. PCT/EP2003/013848 filed 6 Dec. 2003 and published 1 Jul. 2004 as WO 2004/055087, which claims priority from German Application No. 10259249.7, filed 17 Dec. 2002, each of which is incorporated herein by reference in its entirety.

### FIELD OF THE INVENTION

The present invention relates to a method for producing polyurethane prepolymers having terminal isocyanate groups by reacting polyisocyanates with polyols in the presence of a catalyst and relates to the use of the polyurethane prepolymers.

### DISCUSSION OF THE RELATED ART

The reaction between polyisocyanates and polyols in the presence of a catalyst, e.g., a Lewis acid or Lewis base, is known. WO 98/02303 describes a method for the accelerated curing of laminates, in which an ink is applied together with a catalyst almost completely to a first film and subsequently this first film is laminated with the assistance of an adhesive to a second film. The adhesives used can be one-component (1K) or two-component (2K) polyurethane adhesives. Catalysts used with preference are ε-caprolactam, polyethylene glycol, and dibutyltin dilaurate. The films produced by this method are distinguished by shorter aging times and low amine migration. The adhesive systems used according to the examples, however, have a high viscosity, which increases further as a result of the curing in the presence of a catalyst.

DE-A-2330175 describes the use of addition compounds of lactams and hydroxyl compounds and/or amines and/or hydrazines and/or oximes as catalysts in contexts including the lamination of textiles to polyurethanes. Catalysts of this kind result in the generation of foams having a closed and pore-free surface.

DE-A-4136490 describes solvent-free coating systems and adhesive systems which supply low migration values shortly after production and are composed of polyols and prepolymers containing isocyanate groups, in a ratio of isocyanate groups to hydroxyl groups of from 1.05:1 to 2.0:1, the prepolymers containing isocyanate groups being composed of polyol mixtures with an average functionality of 2.05 to 2.5, containing at least 90 mol % of secondary hydroxyl groups and diisocyanates having isocyanate groups of different reactivity, in a ratio of isocyanate groups to hydroxyl groups of from 1.6:1 to 1.8:1. The coating and adhesive systems exhibit a low viscosity and good initial strength.

### SUMMARY OF THE INVENTION

It was an object of the present invention to provide polyurethane prepolymers having terminal NCO groups and a low viscosity which can be produced with shortened reaction times and which without costly and inconvenient workup steps have a low monomeric polyisocyanate content.

The present invention provides a method for producing polyurethane prepolymers having terminal isocyanate groups, which involves reacting polyisocyanates with polyols, and wherein
a) at least one asymmetric diisocyanate is used as polyisocyanate,
b) at least one polyol having an average molecular weight (Mn) of 60 to 3000 g/mol, preferably 100 to 2000 g/mol and more preferably 200 to 1200 g/mol is used as polyol,
c) the ratio of isocyanate groups to hydroxyl groups is set in the range between 1.1:1 to 4:1, preferably 1.2:1 to 2:1, more preferably 1.3:1 to 1.8:1 and very preferably 1.45:1 to 1.75:1, and
d) at least one carboxamide is added as catalyst.

### DETAILED DISCUSSION OF CERTAIN EMBODIMENTS OF THE INVENTION

Surprisingly and unexpectedly, it has been found that when carboxamide is used as catalyst in the reaction of asymmetric diisocyanate with polyol the reaction proceeds selectively such that the polyurethane prepolymers produced by the method of the invention have low viscosities and a low monomeric polyisocyanate content.

Without wishing to be limited to this theory, the applicant is of the view that carboxamides selectively catalytically promote the reaction rate of one NCO group in an asymmetric diisocyanate.

The molecular weight figures referring to polymeric compounds in the text below are based, unless indicated otherwise, on the number-average molecular weight (Mₙ). All molecular weight figures relate, unless indicated otherwise, to values as are obtainable by gel permeation chromatography (GPC).

By polyisocyanates are meant compounds which contain two or more isocyanate groups. Preferably the polyisocyanates are compounds of the general structure O═C═N—X—N═C═O, where X is an aliphatic, alicyclic or aromatic radical, preferably an alicyclic or aromatic radical having 4 to 18 carbon atoms. The polyisocyanate may also be a polyurethane prepolymer having terminal NCO groups, in which case the molecular weight (Mₙ) is not more than 1000 g/mol.

Typical examples of suitable isocyanates are 1,5-naphthylene diisocyanate, 2,4- or 4,4′-diphenylmethane diisocyanate (MDI), hydrogenated MDI (H₁₂MDI), xylylene diisocyanate (XDI), tetramethylxylylene diisocyanate (TMXDI), 4,4′-diphenyldimethylmethane diisocyanate, di- and tetraalkylenediphenylmethane diisocyanate, 4,4′-dibenzyl diisocyanate, 1,3-phenylene diisocyanate, 1,4-phenylene diisocyanate, the isomers of tolylene diisocyanate (TDI), 1-methyl-2,4-diisocyanatocyclohexane, 1,6-diisocyanato-2,2,4-trimethylhexane, 1,6-diisocyanato-2,4,4-trimethylhexane, 1-isocyanatomethyl-3-isocyanato-1,5,5-trimethylcyclohexane (IPDI), chlorinated and brominated diisocyanates, phosphorus-containing diisocyanates, 4,4′-diisocyanatophenylperfluoroethane, tetramethoxybutane 1,4-diisocyanate, butane 1,4-diisocyanate, hexane 1,6-diisocyanate (HDI), dicyclohexylmethane diisocyanate, cyclohexane 1,4-diisocyanate, ethylene diisocyanate, bisisocyanatoethyl phthalate, and also diisocyanates containing reactive halogen atoms, such as 1-chloromethylphenyl 2,4-diisocyanate, 1-bromomethylphenyl 2,6-diisocyanate, and 3,3-bischloromethyl ether 4,4′-diphenyl diisocyanate.

Aromatic diisocyanates are defined by the fact that the isocyanate group is disposed directly on the benzene ring. Use is made in particular of aromatic diisocyanates such as 2,4- or 4,4′-diphenylmethane diisocyanate (MDI), the isomers of tolylene diisocyanate (TDI), or naphthalene 1,5-diisocyanate (NDI).

Sulfur-containing polyisocyanates are obtained, for example, by reacting 2 mol of hexamethylene diisocyanate with 1 mol of thiodiglycol or dihydroxydihexyl sulfide. Further diisocyanates which can be used include for example trimethylhexamethylene diisocyanate, 1,4-diisocyanatobutane, 1,12-diisocyanatododecane and dimer fatty acid diisocyanate. Particular suitability is possessed by the following: tetramethylene, hexamethylene, undecane, dodecamethylene, 2,2,4-trimethylhexane-2,3,3-trimethylhexamethylene, 1,3-cyclohexane, 1,4-cyclohexane, 1,3- and 1,4-tetramethyl-xylene, isophorone, 4,4-dicyclohexylmethane, tetramethylxylylene (TMXDI), and lysine ester diisocyanate.

Compounds suitable as at least trifunctional isocyanates are polyisocyanates formed by trimerizing or oligomerizing diisocyanates or by reacting diisocyanates with polyfunctional hydroxyl- or amino-containing compounds. A suitable example from the group of the aromatic polyisocyanates is methylenetriphenyl triisocyanate (MIT).

Isocyanates suitable for preparing trimers are the diisocyanates already mentioned above, particular preference being given to the trimerization products of the isocyanates HDI, MDI or IPDI.

Additionally suitable are blocked, reversibly masked polykis isocyanates such as 1,3,5-tris[6-(1-methylpropylideneaminoxycarbonylamino)hexyl]-2,4,6-trixo-hexahydro-1,3,5-triazine.

Likewise suitable for use are the polymeric isocyanates such as are produced, for example, as a residue in the liquid distillation phase during the distillation of diisocyanates. A particularly suitable product here is the polymeric MDI as is obtainable from the distillation residue in the distillation of MDI.

In one preferred embodiment of the invention use is made, for example, of DESMODUR N 3300, DESMODUR N 100 or the IPDI-trimeric isocyanurate T 1890 (manufacturer: Bayer AG).

In the selection of the polyisocyanates it should be ensured that the NCO groups of at least one polyisocyanate possess different reactivity toward compounds which carry functional groups that are reactive with isocyanates. This relates in particular to diisocyanates having NCO groups in a different chemical environment, i.e., to asymmetric diisocyanates.

The term “polyol” encompasses for the purpose of the present text a single polyol or a mixture of two or more polyols which can be used for preparing polyurethanes. A polyol is a polyfunctional alcohol, i.e., a compound having more than one OH group in the molecule. The polyol may be a polyetherpolyol, a polyesterpolyol or a polyetheresterpolyol.

Examples of polyols which can be used include aliphatic alcohols having 2 to 4 OH groups per molecule. The OH groups may be both primary and secondary.

The suitable aliphatic alcohols include, for example, ethylene glycol, propylene glycol, butane-1,4-diol, pentane-1,5-diol, hexane-1,6-diol, heptane-1,7-diol, octane-1,8-diol and their higher homologs or isomers such as result for the skilled worker from a stepwise prolongation of the hydrocarbon chain by one CH₂ group in each case or with the introduction of branches into the carbon chain. Likewise suitable are alcohols of higher functionality such as, for example, glycerol, trimethylolpropane, pentaerythritol and also oligomeric ethers of said substances with themselves or in a mixture of two or more of said ethers with one another.

Additionally possible for use as polyol component are reaction products of low molecular weight polyfunctional alcohols with alkylene oxides, referred to as polyethers. The alkylene oxides have preferably 2 to 4 carbon atoms. Suitability is possessed for example by the reaction products of ethylene glycol, propylene glycol, the isomeric butanediols, hexanediols or 4,4′-dihydroxydiphenylpropane with ethylene oxide, propylene oxide or butylene oxide, or mixtures of two or more thereof. Also suitable are the reaction products of polyfunctional alcohols, such as glycerol, trimethylolethane or trimethylolpropane, pentaerythritol or sugar alcohols, or mixtures of two or more thereof, with the stated alkylene oxides to form polyetherpolyols.

Thus it is possible—in accordance with the desired molecular weight—to use adducts of only a few mol of ethylene oxide and/or propylene oxide per mole or else of more than hundred mol of ethylene oxide and/or propylene oxide with low molecular weight polyfunctional alcohols. Further polyetherpolyols are preparable by condensing, for example, glycerol or pentaerythritol with elimination of water.

Polyols commonplace in polyurethane chemistry are additionally formed by polymerizing tetrahydrofuran.

Particular suitability among the aforementioned polyetherpolyols is possessed by the reaction products of polyfunctional alcohols of low molecular weight with propylene oxide under conditions in which, at least partially, secondary hydroxyl groups are formed, especially for the first synthesis stage.

The polyethers are reacted in a way which is known to the skilled worker, by reacting the starter compound containing a reactive hydrogen atom with alkylene oxides, examples being ethylene oxide, propylene oxide, butylene oxide, styrene oxide, tetrahydrofuran or epichlorohydrin or mixtures of two or more thereof.

Examples of suitable starter compounds include water, ethylene glycol, propylene 1,2- or 1,3-glycol, butylene 1,4- or 1,3-glycol, hexene-1,6-diol, octane-1,8-diol, neopentyl glycol, 1,4-hydroxymethylcyclohexane, 2-methyl-1,3-propanediol, glycerol, trimethylolpropane, hexane-1,2,6-triol, butane-1,2,4-triol, trimethylolethane, pentaerythritol, mannitol, sorbitol, methyl glycosides, sugars, phenol, isononylphenol, resorcinol, hydroquinone, 1,2,2- or 1,1,2-tris(hydroxyphenyl)ethane, ammonia, methylamine, ethylenediamine, tetra- or hexamethyleneamine, triethanolamine, aniline, phenylenediamine, 2,4- and 2,6-diaminotoluene and polyphenyl-polymethylenepolyamines such as are obtainable by aniline-formaldehyde condensation, or mixtures of two or more thereof.

Likewise suitable for use as polyol component are polyethers which have been modified by vinylpolymers. Products of this kind are obtainable, for example, by polymerizing styrene- or acrylonitrile, or a mixture thereof, in the presence of polyethers.

For preparing the polyurethane prepolymer with terminal isocyanate groups suitability is possessed likewise by polyesterpolyols. Thus it is possible, for example, to use polyesterpolyols formed by reacting low molecular weight alcohols, especially ethylene glycol, diethylene glycol, neopentyl glycol, hexanediol, butanediol, propylene glycol, glycerol or trimethylolpropane, with caprolactone. Likewise suitable as polyfunctional alcohols for preparing polyesterpolyols are 1,4-hydroxymethylcyclohexane, 2-methyl-1,3-propanediol, butane-1,2,4-triol, triethylene glycol, tetraethylene glycol, polyethylene glycol, dipropylene glycol, polypropylene glycol, dibutylene glycol, and polybutylene glycol.

Further suitable polyesterpolyols can be prepared by polycondensation. For instance, difunctional and/or trifunctional alcohols can be condensed with a substoichiometric amount of dicarboxylic acids and/or tricarboxylic acids, or reactive derivatives thereof, to form polyesterpolyols. Examples of suitable dicarboxylic acids include adipic acid or succinic acid and their higher homologs having up to 16 carbon atoms, and also unsaturated dicarboxylic acids such as maleic acid or fumaric acid, and also aromatic dicarboxylic acids, particularly the isomeric phthalic acids, such as phthalic acid, isophthalic acid or terephthalic acid. Examples of suitable tricarboxylic acids include citric acid or trimellitic acid. Said acids can be used individually or as mixtures of two or more thereof.

Particularly suitable in the context of the invention are polyesterpolyols formed from at least one of the aforementioned dicarboxylic acids and glycerol, having a residual OH group content. Particularly suitable alcohols are hexanediol, ethylene glycol, diethylene glycol or neopentyl glycol or mixtures of two or more thereof. Particularly suitable acids are isophthalic acid or adipic acid or a mixture thereof.

Polyesterpolyols with a high molecular weight can be used in the second synthesis stage and comprise, for example, the reaction products of polyfunctional, preferably difunctional, alcohols (together where appropriate with small amounts of trifunctional alcohols) and polyfunctional, preferably difunctional, carboxylic acids. Instead of free polycarboxylic acids, the corresponding polycarboxylic anhydrides or corresponding polycarboxylic esters with alcohols having preferably 1 to 3 carbon atoms can be used (if possible). The polycarboxylic acids may be aliphatic, cycloaliphatic, aromatic or heterocyclic or both. They may optionally be substituted, such as by alkyl groups, alkenyl groups, ether groups or halogens, for example. Examples of suitable polycarboxylic acids are succinic acid, adipic acid, suberic acid, azelaic acid, sebacic acid, phthalic acid, isophthalic acid, terephthalic acid, trimellitic acid, phthalic anhydride, tetrahydrophthalic anhydride, hexahydrophthalic anhydride, tetrachlorophthalic anhydride, endomethylenetetrahydrophthalic anhydride, glutaric anhydride, maleic acid, maleic anhydride, fumaric acid, dimer fatty acid or trimer fatty acid or mixtures of two or more thereof. If desired it is possible for minor amounts of monofunctional fatty acids to be present in the reaction mixture.

The polyesters may where appropriate have a small fraction of carboxyl end groups. Polyesters obtainable from lactones, based for example on ε-caprolactone, also called “polycaprolactone”, or from hydroxy carboxylic acids, ω-hydroxycaproic acid for example, can likewise be used.

Use may also be made, however, of polyesterpolyols of oleochemical origin. Polyesterpolyols of this kind can be prepared, for example, by complete ring opening of epoxidized triglycerides of an at least partly olefinically unsaturated fatty acid-containing fat mixture with one or more alcohols having 1 to 12 carbon atoms, followed by partial transesterification of the triglyceride derivatives to give alkyl ester polyols having 1 to 12 carbon atoms in the alkyl radical. Further suitable polyols are polycarbonate-polyols and dimer diols (Henkel), and also castor oil and its derivatives. The hydroxy-functional polybutadienes as well, such as are obtainable for example under the trade name “Poly-bd”, can be used as polyols for the compositions of the invention.

Likewise suitable as a polyol component are polyacetals. Polyacetals are compounds as are obtainable from glycols, examples being diethylene glycol or hexanediol or a mixture thereof, with formaldehyde. Polyacetals which can be used in the context of the invention may likewise be obtained by the polymerization of cyclic acetals.

Further suitable polyols are polycarbonates. Polycarbonates can be obtained, for example, by reacting diols, such as propylene glycol, butane-1,4-diol or hexane-1,6-diol, diethylene glycol, triethylene glycol or tetraethylene glycol, or mixtures of two or more thereof, with diaryl carbonates, diphenyl carbonate for example, or phosgene.

Likewise suitable as a polyol component are polyacrylates which carry OH groups. These polyacrylates are obtainable, for example, through the polymerization of ethylenically unsaturated monomers which carry an OH group. Monomers of this kind are obtainable, for example, through the esterification of ethylenically unsaturated carboxylic acids and difunctional alcohols, the alcohol generally being present in a slight excess. Ethylenically unsaturated carboxylic acids suitable for this purpose are, for example, acrylic acid, methacrylic acid, crotonic acid, or maleic acid. Corresponding esters which carry OH groups are, for example, 2-hydroxyethyl acrylate, 2-hydroxyethyl methacrylate, 2-hydroxypropyl acrylate, 2-hydroxypropyl methacrylate, 3-hydroxypropyl acrylate or 3-hydroxypropyl methacrylate, or mixture of two or more thereof.

The diisocyanate used with particular preference in the process of the invention comprises at least one asymmetric diisocyanate. The asymmetric diisocyanate is selected from the group consisting of aromatic, aliphatic, and cycloaliphatic diisocyanates.

Examples of suitable aromatic diisocyanates containing NCO groups of different reactivity are all isomers of tolylene diisocyanate (TDI) either in isomerically pure form or as a mixture of two or more isomers, naphthalene 1,5-diisocyanate (NDI) and 1,3-phenylene diisocyanate. Examples of aliphatic diisocyanates having NCO groups of different reactivity are 1,6-diisocyanato-2,2,4-trimethylhexane, 1,6-diisocyanato-2,4,4-trimethylhexane, and lysine diisocyanate. Examples of suitable cycloaliphatic diisocyanates having NCO groups of different reactivity are 1-isocyanatomethyl-3-isocyanato-1,5,5-trimethylcyclohexane (isophorone diisocyanate, IPDI) and 1-methyl-2,4-diisocyanatocyclohexane, for example.

With particular preference use is made of at least one asymmetric diisocyanate from the group consisting of tolylene diisocyanate (TDI), either in isomerically pure form or as a mixture of two or more isomers, 1-isocyanatomethyl-3-isocyanato-1,5,5-trimethyl diisocyanate (isophorone diisocyanate, IPDI), and 2,4-diphenylmethane diisocyanate.

The polyol used comprises at least one polyol having an average molecular weight (Mₙ) of 60 to 3000 g/mol, preferably 100 to 2000 g/mol and more preferably 200 to 1200 g/mol.

It is preferred to use at least one polyetherpolyol having a molecular weight (Mₙ) of 100 to 3000 g/mol, preferably 150 to 2000 g/mol, and/or at least one polyesterpolyol having a molecular weight of 100 to 3000 g/mol, preferably 250 to 2500 g/mol.

In one preferred embodiment at least one polyol is used which possesses hydroxyl groups of different reactivity. A difference in reactivity exists, for example, between primary and secondary hydroxyl groups.

Specific examples of the polyols for use in accordance with the invention are 1,2-propanediol, 1,2-butanediol, dipropylene glycol, tripropylene glycol, tetrapropylene glycol, the higher homologs of polypropylene glycol having an average molecular weight (number average Mₙ) of up to 3000, in particular up to 2500 g/mol, and also copolymers of polypropylene glycol, examples being block copolymers or random copolymers of ethylene oxide and propylene oxide.

In the method of the invention the ratio of isocyanate groups to hydroxyl groups is set in the range between 1.1:1 to 4:1, preferably 1.2:1 to 2:1, and more preferably 1.3:1 to 1.8:1. In one preferred embodiment of the invention the ratio of isocyanate groups to hydroxyl groups is 1.45:1 to 1.75:1.

The reaction between the at least one asymmetric diisocyanate and the at least one polyol having an average molecular weight (Mₙ) of 60 to 3000 g/mol takes place at a temperature between 20° C. to 80° C., preferably between 40 to 75° C. In one particular embodiment the reaction takes place at room temperature.

In one particular embodiment of the invention the reaction takes place in one or more aprotic solvents. The weight fraction of the reaction mixture in the mixture with the aprotic solvent is 20% to 80%, preferably 30% to 60%, more preferably 35% to 50% by weight.

The reaction in the aprotic solvents takes place at temperatures in the range from 20° C. to 100° C., preferably 25° C. to 80° C., and more preferably from 40° C. to 75° C. By aprotic solvents are meant, for example, halogen-containing organic solvents, but preference is given to acetone, methyl isobutyl ketone or ethyl acetate.

The reaction between the at least one asymmetric diisocyanate and the at least one polyol having an average molecular weight (Mₙ) of 60 to 3000 g/mol to form polyurethane prepolymers having terminal isocyanate groups is carried out in the presence of at least one carboxamide as catalyst.

Carboxamides which can be used with preference have the following general formula (I) and/or (II): 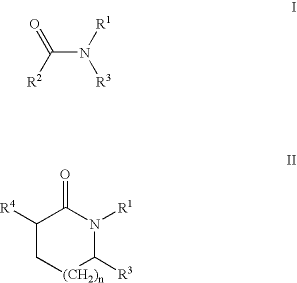
where
R¹, R³, R⁴=H, linear or branched, saturated or unsaturated C₁-C₁₈ alkyl radical, C₅-C₈cycloalkyl, C₆-C₁₀ aryl, C₇-C₁₂ aralkyl; where the groups R¹, R³ and R⁴ can be identical or different from one another,
R²=linear or branched, saturated or unsaturated C₁-C₁₈ alkyl radical; C₅-C₈ cycloalkyl, C₆-C₁₀ aryl, C₇-C₁₂ aralkyl,
n=1 to 3.

In particular the following carboxamides are employed as catalyst:
acetamide, N-methylacetamide, N,N′-dimethylacetamide, N-ethylpropionamide, N-methylbenzamide, benzamide (benzoic acid amide), N-methyl-ε-caprolactam, 3-ethyl-ε-caprolactam, 3-methyl-ε-caprolactam, ε-caprolactam, 7-phenyl-ε-caprolactam, 6-aminohex-2-enolactam, 7-aminoheptanolactam, omega-capryllactam, delta-valerolactam (2-piperidinone), gamma-butyrolactam. Preference is given to using methylacetamide, N-methylbenzamide and/or benzamide as catalyst.

With particular preference the carboxamides have a cyclic structure. Among the cyclic carboxamides preference is given to lactams or lactam derivatives.

In principle there are no restrictions known with regard to the lactam. Suitable lactams are preferably those of C₄-C₂₀ omega-carboxylic acids, particularly 4-aminobutanolactam, 5-aminopentanolactam, 6-aminohexanolactam (“ε-caprolactam”), 7-aminoheptanolactam or 8-aminooctanolactam. These lactams can be substituted, as for example by C1-C4 alkyl groups, halogens, such as fluorine, chlorine or bromine, C1-C4 alkoxy groups or C1-C4 carboxyl groups; preferably the lactams are not substituted.

Carboxamides are obtainable for example by reacting carboxylic acid derivatives with ammonia and/or amines.

Particularly suitable starting compounds for preparing the catalysts for use in accordance with the invention are lactams of omega-aminocarboxylic acids, such as 3-aminopropionic acid, 4-aminobutyric acid, 5-aminovaleric acid, 6-aminocaproic acid, 10-aminocapric acid; N-substituted azalactams such as 1-N-methylhexahydro-1,4-diazepin-3-one, 1-N-butylhexahydro-1,4-diazepin-3-one, 1-N-benzylhexahydro-1,4-diazepin-3-one, 1-N-alpha-pyridylhexahydro-1,4-diazepin-3-one, and so on. Preferred lactams are butyrolactam, valerolactam, 1-N-methylhexahydro-1,4-diazepin-3-one and, in particular, ε-caprolactam.

In one particularly preferred embodiment of the invention the catalyst used is ε-caprolactam.

Relative to the total amount of polyol and polyisocyanate used, the amount of carboxamide used is 0.05% to 6%, preferably 0.1% to 3%, more preferably 0.2% to 0.8% by weight.

In a second synthesis stage it is possible to add further polyol to the polyurethane prepolymers containing terminal isocyanate groups that are prepared by the method of the invention. The further polyol may be a polyetherpolyol, polyesterpolyol or polyetheresterpolyol or a mixture of said polyols. The polyol has a molecular weight (Mₙ) of about 100 to 10,000 g/mol, preferably of about 200 to about 5000 g/mol.

Besides the polyols specified so far it is additionally possible to use further compounds, carrying functional groups that are reactive with/toward isocyanates, for preparing the polyurethane prepolymer; for example, amines, but also water. Specific mention may further be made of the following:
N,N′-bis(2-hydroxyethyl)succinamide, N,N′-bismethyl(2-hydroxy-ethyl)succinamide, 1,4-di(2-hydroxymethylmercapto)-2,3,5,6-tetrachlorobenzene, 2-methylenepropane-1,3-diol, 2-methylpropane-1,3-diol, 3-pyrrolidino-1,2-propanediol, 2-methylenepentane-2,4-diol, 3-alkoxy-1,2-propanediol, 2-ethylhexane-1,3-diol, 2,2-dimethylpropane-1,3-diol, 1,5-pentanediol, 2,5-dimethyl-2,5-hexanediol, 3-phenoxy-1,2-propanediol, 3-benzyloxy-1,2-propanediol, 2,3-dimethyl-2,3-butanediol, 3-(4-methoxyphenoxy)-1,2-propanediol and hydroxymethylbenzyl alcohol;
aliphatic, cycloaliphatic, and aromatic diamines such as ethylenediamine, hexamethylenediamine, 1,4-cyclohexylenediamine, piperazine, N-methylpropylenediamine, diaminodiphenyl sulfone, diaminodiphenyl ether, diaminodiphenyldimethylmethane, 2,4-diamino-6-phenyltriazine, isophoronediamine, dimer fatty acid diamine, diaminodiphenylmethane, aminodiphenylamine or the isomers of phenylenediamine;
additionally also carbohydrazides or hydrazides of dicarboxylic acids;
amino alcohols such as ethanolamine, propanolamine, butanolamine, N-methylethanolamine, N-methylisopropanolamine, diethanolamine, triethanolamine and also higher di- or tri(alkanolamines);
aliphatic, cycloaliphatic, aromatic, and heterocyclic mono- and diamino carboxylic acids such as glycine, 1- and 2-alanine, 6-aminocaproic acid, 4-aminobutyric acid, the isomeric mono- and diaminobenzoic acids and also the isomeric mono- and diaminonaphthoic acids.

Furthermore, the polyurethane prepolymer containing terminal isocyanate groups may if desired further comprise stabilizers, adhesion promoter additives such as tackifying resins, fillers, pigments, plasticizers and/or solvents.

“Stabilizers” in the sense of this invention are on the one hand stabilizers which stabilize the viscosity of the polyurethane of the invention in the course of production, storage and/or application. Examples of compounds suitable for this purpose are monofunctional carbonyl chlorides, monofunctional isocyanates of high reactivity, but also noncorrosive inorganic acids; by way of example mention may be made of benzoyl chloride, toluenesulfonyl isocyanate, phosphoric acid or phosphorous acid. Stabilizers in the sense of this invention are additionally antioxidants, UV stabilizers or hydrolysis stabilizers. The selection of these stabilizers is guided on the one hand by the major components of the polyurethane of the invention and on the other by the application conditions and also the anticipated exposures of the cured product. If the low-monomer-content polyurethane of the invention is constructed predominantly from polyether units, the primary need is for antioxidants, where appropriate in combination with UV protectants. Examples thereof are the commercially customary sterically hindered phenols and/or thioethers and/or substituted benzotriazoles or the sterically hindered amines of the HALS type (“hindered amine light stabilizer”).

Where substantial constituents of the polyurethane prepolymer containing terminal isocyanate groups are composed of polyester units, it is possible to use hydrolysis stabilizers, examples being those of the carbodiimide type.

Where the polyurethane prepolymers containing terminal NCO groups that are produced by the method of the invention are used in laminating adhesives, these may further comprise tackifying resins, such as abietic acid, abietic esters, terpene resins, terpene-phenolic resins or hydrocarbon resins, for example, and also fillers (e.g., silicates, talc, calcium carbonates, clays or carbon black), plasticizers (e.g., phthalates) or thixotropic agents (e.g., Bentone, pyrogenic silicas, urea derivatives, fibrillated or pulp short fibers) or color pastes and/or pigments.

Additionally in this case it is possible for the polyurethane prepolymers produced by the method of the invention to be prepared also in solution and to be used as a 1K or 2K laminating adhesive, preferably in polar, aprotic solvents. The preferred solvents in this case have a boiling range of about 50° C. to 140° C. Although halogenated hydrocarbons are also suitable, very particular preference is given to ethyl acetate, methyl ethyl ketone (MEK) or acetone.

In one particular embodiment of the method of the invention use is made, in a second or further synthesis stage, of further polyisocyanates, especially diisocyanates, but preferably triisocyanates. This can take place in combination with the polyol or else by sole addition of the diisocyanate/triisocyanate. Preferred triisocyanate comprises adducts of diisocyanates and low molecular weight triols, particularly the adducts of aromatic diisocyanates and triols, such as trimethylolpropane or glycerol, for example.

Aliphatic triisocyanates as well, such as the biuretization product of hexamethylene diisocyanate (HDI) or the isocyanuratization product of HDI, for example, or else the same trimerization products of isophorone diisocyanate (IPDI), are suitable for the compositions of the invention, provided the fraction of diisocyanates amounts to <1% by weight and the fraction of isocyanates with a functionality of four or more is not greater than 25% by weight.

On account of their ready availability, the aforementioned trimerization products of HDI and of IPDI are particularly preferred in this context.

The further polyisocyanate can be added at a temperature of 25° C. to 100° C.

The polyurethane prepolymer containing terminal isocyanate groups that is produced by the method of the invention is of low monomer content. “Of low monomer content” means a low concentration of the starting polyisocyanates in the polyurethane prepolymer produced in accordance with the invention.

The monomer concentration is below 1%, preferably below 0.5%, in particular below 0.3% and more preferably below 0.1% by weight, based on the total weight of the solvent-free polyurethane prepolymer.

The weight fraction of the monomeric diisocyanate is determined gas-chromatographically, by means of high-pressure liquid chromatography (HPLC) or by means of gel permeation chromatography (GPC).

The viscosity of the polyurethane prepolymer produced by the method of the invention amounts at 100° C. to 100 mPas to 15,000 mPas, preferably 150 mPas to 12,000 mPas, and more preferably 200 to 10,000 mPas, measured by Brookfield (ISO 2555). In one particularly preferred embodiment of the invention, the viscosity of the polyurethane prepolymers produced in accordance with the invention amounts to 4000 mPas to 9000 mPas at 40° C., measured by Brookfield (ISO 2555).

The NCO content in the polyurethane prepolymer produced in accordance with the invention amounts to 1% to 10% by weight, preferably 2% to 8% by weight, and more preferably 2.2% to 6% by weight (by the method of Spiegelberger, EN ISO 11909).

The polyurethane prepolymers produced in accordance with the invention are notable in particular for an extremely low fraction of monomeric diisocyanates of low volatility with a molecular weight of below 500 g/mol, such diisocyanates being objectionable from the standpoint of occupational hygiene. The method has the economic advantage that the low monomer concentration is obtained without costly and inconvenient worksteps. Furthermore, the polyurethane prepolymers thus produced are free from the by-products that are normally produced in steps of workup by thermal demonomerization, such as crosslinking products or depolymerization products.

By virtue of the method of the invention, shorter reaction times are obtained and yet the selectivity, particularly that between the NCO groups of an asymmetric diisocyanate that are of different reactivity, is maintained to such an extent that polyurethane prepolymers having low viscosities are obtained.

The polyurethane prepolymers produced in accordance with the invention are suitable, as they are without solvent or as a solution in organic solvents, preferably as an adhesive or sealant or as an adhesive or sealant component for the adhesive bonding of plastics, metals, and paper or as a low-monomer content, low-viscosity synthesis unit for synthesizing polyurethane prepolymers. In view of the extremely low fraction of migratable monomeric diisocyanates, the polyurethane prepolymers produced in accordance with the invention are especially suitable for laminating textiles, aluminum and polymeric films and also papers and films which have been vapor-coated with metal and/or oxide. In these contexts it is possible to add customary curing agents, such as polyfunctional polyols of relatively high molecular weight (two-component systems), or else surfaces having a defined moisture content can be bonded directly with the products produced in accordance with the invention.

Film composites produced on the basis of the polyurethane prepolymers produced in accordance with the invention exhibit a high level of processing reliability during hot sealing. This can be attributed to the significantly reduced fraction of migratable products of low molecular weight in the polyurethane. Moreover, the low-monomer-content polyurethane prepolymers containing NCO groups that are produced in accordance with the invention can also be used in extrusion primers, print primers and metalizing primers and also for hot sealing. Moreover, the polyurethane prepolymers produced in accordance with the invention are suitable for producing rigid foams, flexible foams, and integral foams, and also in sealants.

The invention is now elucidated in detail with reference to examples.

### EXAMPLES

### Example 1

Initial mass

| | | |
|---|---|---|
| 630.32 g | polyetherpolyol 1 | (OHN: 108) |
| 207.60 g | TDI | (NCO: 48.2%) |
| 157.08 g | polyetherpolyol 2 | (OHN: 53) |
| 5.00 g | catalyst | |
| | (ε-caprolactam) | |

Design:
Apparatus: stirred, three-necked flask apparatus with contact thermometer, stirrer with stirring motor, drying tube and heating mantle.
   Procedure:

Polyetherpolyol 1 is introduced and the catalyst (ε-caprolactam) is added. Subsequently TDI is added. After the exothermic reaction has subsided the mixture is stirred at about 70-80° C. until the endpoint of the 1st stage has been reached.

Endpoint of the 1st stage: 5.8% by weight NCO in the polyurethane prepolymer. Subsequently polyetherpolyol 2 is added. The reaction mixture is stirred again at about 70-80° C.

Endpoint of the 2nd stage: 4.0% by weight NCO in the polyurethane prepolymer. The total reaction time for the first and second stages for producing the polyurethane prepolymer amounts to 3 hours.

| | |
|---|---|
| NCO value: | 4.0% by weight |
| Viscosity: | 4000-6000 mPa s |
| (Brookfield, type RVT; | |
| spindle 27; 50 rpm; 40° C.) | |
| TDI monomer content: | 0.03% by weight |

### Example 2

Initial mass

| | | |
|---|---|---|
| 630.32 g | polyetherpolyol 1 | (OHN: 105) |
| 207.60 g | TDI | (NCO: 48.2%) |
| 157.08 g | polyetherpolyol 2 | (OHN: 53) |
| 5.00 g | catalyst (benzamide) | |

Design:
Apparatus: stirred, three-necked flask apparatus with contact thermometer, stirrer with stirring motor, drying tube and heating mantle.
   Procedure:

Polyetherpolyol 1 is introduced and the catalyst is added. After the catalyst has completely dissolved, TDI is added. After the exothermic reaction has subsided the mixture is stirred at about 70-80° C. until the endpoint of the 1st stage has been reached.

Endpoint of the 1st stage: 5.8% by weight NCO in the polyurethane prepolymer
(theory: 6.0% by weight)

Subsequently polyetherpolyol 2 is added. The reaction mixture is stirred again at about 70-80° C.

Endpoint of the 2nd stage: 3.6% by weight NCO in the polyurethane prepolymer.
(theory: 4.4% by weight)

The total reaction time for the first and second stages for producing the polyurethane prepolymer amounts to 6 hours.

| | |
|---|---|
| NCO value: | 3.6% by weight |
| Viscosity: | 7500-8500 mPa s |
| (Brookfield, type RVT; | |
| spindle 27; 50 rpm; 40° C.) | |
| TDI monomer content: | <0.01% by weight |

### Example 3

### Not Inventive

Initial mass

| | | |
|---|---|---|
| 631.38 g | polyetherpolyol 1 | (OHN: 108) |
| 188.97 g | TDI | (NCO: 48.2%) |
| 176.65 g | polyetherpolyol 2 | (OHN: 53) |
| 3.00 g | catalyst | |
| | (DABCO) | |

Design:
Apparatus: stirred, three-necked flask apparatus with contact thermometer, stirrer with stirring motor, drying tube and heating mantle.
   Procedure:

Polyetherpolyol 1 is introduced and the catalyst (DABCO) is added. Subsequently TDI is added. After the exothermic reaction has subsided the mixture is stirred at about 70-80° C. until the endpoint of the 1st stage has been reached.

Endpoint of the 1st stage: 5.5% by weight NCO in the polyurethane prepolymer. Subsequently polyetherpolyol 2 is added. The reaction mixture is stirred again at about 70-80° C.

Endpoint of the 2nd stage: 3.9% by weight NCO in the polyurethane prepolymer. The total reaction time for the first and second stages for producing the polyurethane prepolymer amounts to 3 hours.

| | |
|---|---|
| NCO value: | 3.5% by weight |
| Viscosity: | 28,000-32,000 mPa s |
| (Brookfield, type RVT; | |
| spindle 27; 50 rpm; 40° C.) | |
| TDI monomer content: | 0.03% by weight |

### Example 4

### Not Inventive

Initial mass

| | | |
|---|---|---|
| 631.38 g | polyetherpolyol 1 | (OHN: 108) |
| 188.97 g | TDI | (NCO: 48.2%) |
| 176.65 g | polyetherpolyol 2 | (OHN: 53) |

Design
Apparatus: stirred, three-necked flask apparatus with contact thermometer, stirrer with stirring motor, drying tube and heating mantle.
   Procedure:

Polyetherpolyol 1 is introduced. Subsequently TDI is added. After the exothermic reaction has subsided the mixture is stirred at about 70-80° C. until the endpoint of the 1st stage has been reached.

Endpoint of the 1st stage: 7.1% by weight NCO in the polyurethane prepolymer. Subsequently polyetherpolyol 2 is added. The reaction mixture is stirred again at about 70-80° C.

Endpoint of the 2nd stage: 4.8% by weight in the polyurethane prepolymer. The total reaction time for the first and second stages for producing the polyurethane prepolymer amounts to 5 hours.

| | |
|---|---|
| NCO value: | 4.8% by weight |
| Viscosity: | 3250 mPa s |
| (Brookfield, type RVT; | |
| spindle 27; 50 rpm; 40° C.) | |
| TDI monomer content: | 0.55% by weight |

What is claimed is:

1) A method for producing a polyurethane prepolymer having terminal isocyanate groups, said method comprising reacting one or more polyisocyanates with one or more polyols, wherein
a) at least one asymmetric diisocyanate is used;
b) at least one polyol having an average molecular weight (Mₙ) of 60 to 3000 g/mol is used;
c) the ratio of isocyanate groups to hydroxyl groups is set in the range between 1.1:1 to 4:1; and
d) at least one carboxamide is used as catalyst.

2) The method of claim 1, wherein at least one asymmetric diisocyanate selected from the group consisting of tolylene diisocyanate (TDI), 1-isocyanatomethyl-3-isocyanato-1,5,5-trimethyl diisocyanate (isophorone diisocyanate, IPDI), and 2,4-diphenylmethane diisocyanate is used.

3) The method of claim 1, wherein at least one carboxamide of the general formula I and/or II is used: 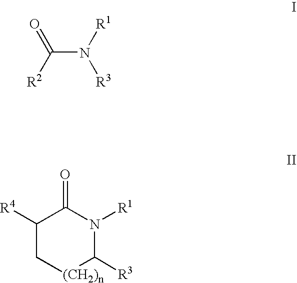
where
R¹, R³, R⁴=H, linear or branched, saturated or unsaturated C₁-C₁₈ alkyl radical, C₅-C₈ cycloalkyl, C₆-C₁₀ aryl, C₇-C₁₂ aralkyl; where the groups R¹, R³ and R⁴ can be identical or different from one another,
R²=linear or branched, saturated or unsaturated C₁-C₁₈ alkyl radical; C₅-C₈ cycloalkyl, C₆-C₁₀ aryl, C₇-C₁₂ aralkyl,
n=1 to 3.

4) The method of claim 1, wherein at least one catalyst selected from the group consisting of acetamide, N-methylacetamide, N,N′-dimethylacetamide, N-ethylpropionamide, N-methylbenzamide, benzamide (benzoic acid amide), N-methyl-ε-caprolactam, 3-ethyl-ε-caprolactam, 3-methyl-ε-caprolactam, ε-caprolactam, 7-phenyl-ε-caprolactam, 6-aminohex-2-enolactam, 7-amino-heptanolactam, omega-capryllactam, delta-valerolactam (2-piperidinone), and gamma-butyrolactam is used.

5) The method of claim 1, wherein at least one lactam of a C₄-C₂₀ omega-carboxylic acid is used as a catalyst.

6) The method of claim 1, wherein the polyurethane prepolymer produced has a monomer concentration below 0.3% by weight, based on the total weight of the solvent-free polyurethane prepolymer.

7) The method of claim 1, wherein the polyurethane prepolymer produced has a viscosity at 100° C. in the range from 100 mPas to 15 000 mPas (measured by Brookfield, ISO 2555).

8) The method of claim 1, wherein said polyurethane prepolymer has an NCO content of from 1% to 10% by weight.

9) The method of claim 1, wherein the at least one polyol has an average molecular weight of 100 to 2000 g/mol.

10) The method of claim 1, wherein the at least one polyol has an average molecular weight of 200 to 1200 g/mol.

11) The method of claim 1, wherein the ratio of isocyanate groups to hydroxyl groups is set in the range between 1.2: to 2:1.

12) The method of claim 1, wherein the ratio of isocyanate groups to hydroxyl groups is set in the range between 1.3:1 to 1.8:1.

13) The method of claim 1, wherein the ratio of isocyanate groups to hydroxyl groups is set in the range between 1.45:1 to 1.75:1.

14) The method of claim 1, wherein said at least one carboxamide is used in a concentration of 0.05% to 6% by weight.

15) The method of claim 1, wherein said at least one carboxamide is used in a concentration of 0.1% to 3% by weight.

16) The method of claim 1, wherein said at least one carboxamide is used in a concentration of 0.2% to 0.8% by weight.

17) The method of claim 1, wherein said at least one polyol is selected from the group consisting of polyetherpolyols and polyesterpolyols.

18) The method of claim 1, wherein said at least one carboxamide has a cyclic structure.

19) The method of claim 1, wherein said at least one carboxamide is a lactam or lactam derivative.

20) The method of claim 1, wherein said polyurethane prepolymer is reacted in a second stage with a further polyol.

21) The method of claim 1, wherein said at least one carboxamide is selected from the group consisting of butyrolactam, valerolactam, 1-N-methylhexahydro-1,4-diazepin-3-one and ε-caprolactam.
